(19) United States
(12) Patent Application Publication
(10) Pub. No.: US 2018/0042803 A1
(43) Pub. Date: Feb. 15, 2018

(54) Exoskeleton and Method of Transferring a Weight of a Load from the Exoskeleton to a Support Surface

(71) Applicant: Ekso Bionics, Inc., Richmond, CA (US)

(72) Inventor: Kurt Amundson, Berkeley, CA (US)

(73) Assignee: Ekso Bionics, Inc., Richmond, CA (US)

(21) Appl. No.: 15/541,072

(22) PCT Filed: Dec. 30, 2015
(86) PCT No.: PCT/US15/68106

§ 371 Date: Jun. 30, 2017

Related U.S. Application Data
(60) Provisional application No. 62/097,978, filed on Dec. 30, 2014.

(51) Int. Cl. A61H 1/02; B25J 9/14; B25J 9/10; B25J 9/00

(52) U.S. Cl. CPC A61H 1/0237; B25J 9/0006; B25J 9/14; B25J 9/1075; A61H 2201/018; A61H 2201/1246; A61H 2201/1454; A61H 2201/503; A61H 2201/165; A61H 2205/12; A61H 2205/08; A61H 2201/5071; A61H 2201/0196

(57) ABSTRACT

An exoskeleton comprises at least one load-bearing element including a flexible hose, sleeve or cable having a first end portion and a second end portion opposite the first end portion. The first end portion is engageable with a load and is configured to transfer a weight of the load to the hose, sleeve or cable. The hose, sleeve or cable is configured to transfer the weight of the load from the first end portion to the second end portion, and the second end portion is configured to transfer the weight of the load to a support surface upon which the exoskeleton is supported.

### CROSS REFERENCE TO RELATED APPLICATIONS

This application claims the benefit of U.S. Provisional Patent Application Ser. No. 62/097,978, which was filed on Dec. 30, 2014 and titled “Flexible Structures for Load Bearing Exoskeletons”. The entire content of this application is incorporated by reference.

### BACKGROUND OF THE INVENTION

The present invention pertains to exoskeletons that assist people in carrying heavy loads through the use of flexible structures, this being uniquely possible because of the parallel nature of exoskeletons. Although it is not obvious that a flexible structure can bear weight, it is possible in the case of exoskeleton design because an exoskeleton acts in parallel with a person, similar to the way scaffolding works in parallel with a building.

There exists a body of exoskeleton design having different theories regarding load carriage and related problems. These theories are divided into several categories as discussed below.

Energy Transfer

Energy transferring exoskeletons seek to reduce metabolic cost by transferring power from an exoskeleton to a person. To do so, the exoskeleton creates a force in the direction of the person's motion, and the person must accommodate the addition of that force to his/her gait cycle, for example. This does not require that the force is identical to one that the person would generate during walking (i.e., it need not be correspond to clinical gait analysis data) or that the force be applied across a single degree of freedom. Examples of such devices include most military systems. While these devices can help reduce metabolic cost, they do not provide any support to the load, thereby requiring that the person bear any load through his/her body and increasing the possibility of load-related injuries.

Table 1, which is reproduced from Friedl et al., Military Quantitative Physiology: Problems and Concepts in Military Operational Medicine, Fort Detrick, Office of the Surgeon General, 2012, lists sources of injury among soldiers during a road march. The original study listed a 46 kg load, and the major causes of injury during marching were: blisters, back pain, metatarsalgia, leg strain, sprains, knee pain and foot contusions. Friedl et al. notes that “[i]njuries associated with load carriage, although generally minor, can adversely affect an individual's mobility and thus reduce the effectiveness of an entire unit”. Exoskeleton designs that seek to minimize metabolic cost without assisting in reducing the load borne by a person will not address such injuries.

TABLE 1
Injuries Among 355 Infantry Soldiers During a 20 km
Maximal Effort Road March

| | During March* | | | | |
|---|---|---|---|---|---|
| | | Soldier | | | |
| | Soldier | Did Not | 1-12 Days | | |
| | Continued | Continue | Post-March | Totals | |
| Injury | March (n) | March (n) | (n)** | N | % |
| Foot Blisters | 16 | 0 | 19 | 35 | 38 |
| Back Pain/strain | 5 | 7 | 9 | 21 | 23 |
| Metatarsalgia | 1 | 1 | 9 | 11 | 12 |
| Leg Strain/Pain | 0 | 0 | 7 | 7 | 8 |
| Sprains | 1 | 1 | 4 | 6 | 7 |
| Knee Pain | 0 | 0 | 4 | 4 | 4 |
| Foot Contusion | 0 | 1 | 1 | 2 | 2 |
| Other | 1 | 2 | 2 | 5 | 5 |
| Total | 24 | 12 | 55 | 91 | 100 |

*From medics and physicians during the march
**From medical records after the march

Parallel Load Path

An exoskeleton using a parallel load path employs a rigid frame that transfers the weight of a load attached to the exoskeleton directly to the ground. By careful selection of the geometry, it is possible to transfer nearly the entire load to the ground during the stance phase. For example, Walsh, “A Quasi-Passive Leg Exoskeleton for Load-Carrying Augmentation”, International Journal of Humanoid Robotics, Vol. 4.3, 2007, pp. 487-506 includes experimental data showing that approximately 80% of the load is transferred to the ground in single stance. In some designs, limited actuation such as clutched springs and dampers are used to control motion at the hip or, more commonly, the knee. The principle difficulty is that flexion resistance at the knee must cease before the person attempts to move a leg to the swing cycle. Furthermore, the rigid elements may be difficult to size and have a deleterious impact on metabolic cost. While these devices can help bear the weight of a load, they often incur a high metabolic cost due to the rigid, high inertia structural elements. Attaching significant distal mass to the legs of a person is well known to impart a significant metabolic cost. Furthermore, the designs are complex, requiring numerous bearings and rotations to accommodate normal human motion.

Full Frame, Full Power Exoskeletons

In a full frame, full power exoskeleton, a rigid frame is outfitted with n degrees of freedom and n corresponding actuators, with each actuator being sized according to the torque requirements of the exoskeleton and payload weights. In some embodiments, there may be unactuated degrees of freedom (i.e., n degrees of freedom and in actuators where in <n), but the number of actuated degrees of freedom is high: at least six and often a dozen or more. A control scheme that seeks to minimize human-exoskeleton forces, either through direct measurement or estimation, ensures that all of the load attached to the exoskeleton is borne by the exoskeleton. The limitation of this type of device is the incredible power budget required, typically in the kilowatts range, which inescapably results in liquid-fueled power supplies. Examples include the UC Berkeley BLEEX and SARCO Raytheon XOS2. Although such devices have the potential to bear loads while not incurring large metabolic costs, they have proven impractical in implementation. In particular, the power and complexity required to drive the rigid frame elements make the devices essentially unusable.

Current State of the Art

As shown above, the prior art is not well suited to assist in load carriage. Devices that purely seek to address metabolic cost will not significantly reduce joint pain or injuries and may not decrease completion time. Load bearing devices that seek to reduce joint pain or injuries are too heavy to assist with metabolic cost. Full frame exoskeletons are too complex and heavy to be fieldable even if they could address these other issues.

Other efforts to produce a device include the recent DARPA Warrior Web program (http://www.darpa.mil/Our_Work/BTO/Programs/Warrior_Web.aspx), which notes that:
“The amount of equipment and gear carried by today's dismounted warfighter can exceed 100 pounds, as troops conduct patrols for extended periods over rugged and hilly terrain. The added weight while bending, running, squatting, jumping and crawling in a tactical environment increases the risk of musculoskeletal injury, particularly on vulnerable areas such as ankles, knees and lumbar spine. Increased load weight also causes increase in physical fatigue, which further decreases the body's ability to perform warfighter tasks and protect against both acute and chronic injury”.
   As a result, Warrior Web systems have almost exclusively relied on tensile structures and tensile actuators, which do not address transferring the weight of a payload around a soldier nor the injuries commonly sustained on marches due to this load carriage. Indeed, purely tensile actuation must increase the joint loads borne by the soldier, potentially increasing the risk of injury.

It is therefore seen that there exists an unmet need in the art for an exoskeleton that can help bear the weight of a load without having great complexity or mass. Accordingly, the present invention seeks to transfer a load to the ground without rigid elements and use those same structural elements to provide assistive power, thereby providing both metabolic assistance and a parallel load path.

### SUMMARY OF THE INVENTION

The present invention is directed to an exoskeleton comprising at least one load-bearing element. The load-bearing element includes a flexible hose, sleeve or cable having a first end portion and a second end portion opposite the first end portion. The first end portion is engageable with a load and is configured to transfer a weight of the load to the hose, sleeve or cable. The hose, sleeve or cable is configured to transfer the weight of the load from the first end portion to the second end portion, and the second end portion is configured to transfer the weight of the load to a support surface upon which the exoskeleton is supported.

In one embodiment, the load-bearing element is a mechanical control cable or a push-pull cable. In another embodiment, the load-bearing element includes a first hydraulic cylinder located at the first end portion and a second hydraulic cylinder located at the second end portion. In this embodiment, the hose, sleeve or cable is a hydraulic hose containing hydraulic fluid. Furthermore, the first hydraulic cylinder, the second hydraulic cylinder and the hydraulic hose form a portion of a hydraulic circuit. The hydraulic circuit includes a pump, which selectively increases an amount of hydraulic fluid in the hydraulic hose to provide power to the load-bearing element. In one embodiment, the load-bearing element constitutes a first load-bearing element, and the exoskeleton further comprises a second load-bearing element. In this embodiment, the hydraulic circuit also comprises a valve having a first state and a second state. In the first state, the pump is configured to increase an amount of hydraulic fluid in the first load-bearing element and, in the second state, the pump is configured to increase an amount of hydraulic fluid in the second load-bearing element. In another embodiment, the hydraulic circuit further comprises a reservoir and an accumulator.

In a preferred embodiment, the load-bearing element is configured to follow at least one line of non-extension of a wearer of the exoskeleton. Preferably, the load-bearing element follows the at least one line of non-extension over at least a majority of a length of the load-bearing element. In one embodiment, the first end portion is configured to be located adjacent to a torso of the wearer, and the second end portion is configured to be located adjacent a foot of the wearer. In certain embodiments, the first end portion is configured to directly contact the load, and the second end portion is configured to directly contact the support surface.

The exoskeleton further comprises a textile configured to be worn by the wearer. The hose, sleeve or cable is coupled to the textile. Preferably, the textile is form-fitting with respect to the wearer. Also, a mass of the load-bearing element is preferably less than or equal to 1 kilogram per meter of the load-bearing element.

Additional objects, features and advantages of the invention will become more readily apparent from the following detailed description of the invention when taken in conjunction with the drawings wherein like reference numerals refer to corresponding parts in the several views.

### BRIEF DESCRIPTION OF THE FIGURES

FIG. 1 is a perspective view of a dummy showing lines of non-extension;

FIG. 2 is perspective view of a portion of an exoskeleton load-bearing assembly and an exoskeleton wearer in accordance with the present invention;

FIG. 3 is a side view of a test setup used as a proof of concept of the present invention;

FIG. 4 illustrates potential failure modes of a load-bearing element coupled to a leg of a wearer by a textile;

FIG. 5 is a rear view of the load-bearing assembly and wearer of FIG. 2;

FIG. 6 shows two timing diagrams for an exoskeleton in accordance with the present invention;

FIG. 7 is a hydraulic circuit schematic of a load-bearing assembly in accordance with one embodiment of the present invention; and

FIG. 8 is a hydraulic circuit schematic of a load-bearing assembly in accordance with another embodiment of the present invention.

### DETAILED DESCRIPTION OF THE PREFERRED EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

The structure used to achieve a parallel load path in exoskeletons of the prior art is the primary contributor to their metabolic cost and is necessary only to prevent buckling of the structure, not to support the underlying load. Typical loads carried by a soldier (e.g., 75 lb) do not require large amounts of material for support due to pure tensile or compressive loads. The additional material is required to prevent what would otherwise be a thin structure from buckling. For example, a 75 lb load could be borne by a ⅛ inch diameter fiberglass rod, including a generous factor of safety, if buckling was not a problem. The additional material needed to prevent the exoskeleton structure from buckling does not help a wearer (i.e., a user) of the exoskeleton in any way, yet it adds most of the mass of the exoskeleton. It is possible to avoid this if a thin, light structure is tightly coupled to the wearer in the way that scaffolding is coupled to a building. The wearer can prevent buckling of the structure while the structure bears the load.

Tightly coupling the structure to the wearer, however, is complicated by both the bending and linear motion of the person such that the structure must not be rigid. In the prior art, as documented above, exoskeletons have used rigid, outboard structure that crudely approximates the bending and stretching of the underlying person. Such structures are unwieldy, contribute significantly to metabolic cost and are unnatural to use. However, scientists, faced with the problem of keeping a flexible pressure suit from bulging off a person in a vacuum, have determined that there exist lines of non-extension over the human body along which the skin does not appreciably stretch during motion. See, e.g., Iberall, A. S., “The Experimental Design of a Mobile Pressure Suit”, Journal of Basic Engineering, Vol. 92.2, (1970), pp. 251-264.

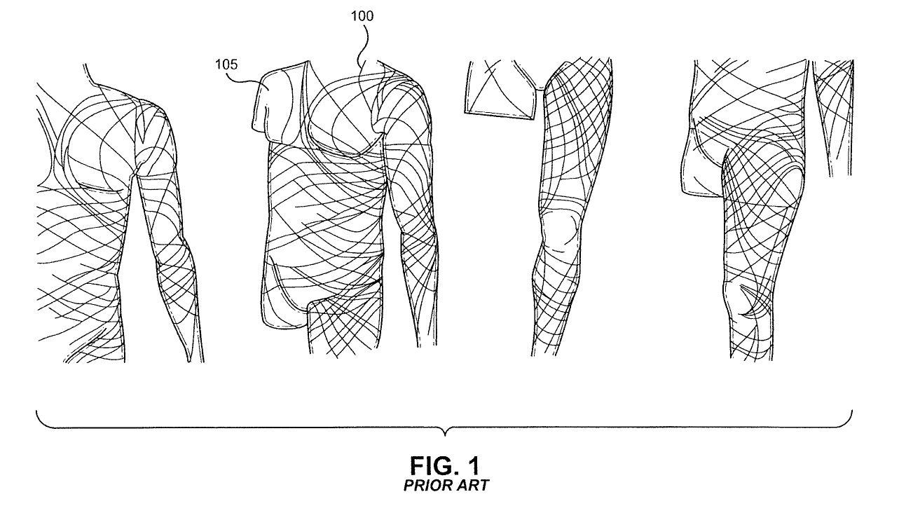

FIG. 1 shows such lines of non-extension (one of which is labeled 100) over the surface of a dummy 105. In connection with the present invention, these lines of non-extension represent locations to which it is possible to attach a structural element that is flexible (because the lines bend) but compressively stiff (because the lines do not extend). Specifically, along these lines of non-extension, it is possible to attach flexible load-bearing elements such as mechanical control cables (or “push-pull” cables) that are lithe, low-weight and capable of handling more than 100 lb of force in compression. In such embodiments, the load-bearing element includes a cable or flexible bearing assembly inside a thin, low-friction sleeve. Flexball™, manufactured by DURA Automotive System GmbH of Germany, is one such cable, but many similar control assemblies are available. In a preferred arrangement, an alternative structure can be fabricated by connecting two hydraulic cylinders with a length of hydraulic hose containing hydraulic fluid. Such embodiments allow a designer more control over the load-bearing element and have actuation benefits, which will be discussed below. Also, the hydraulic fluid is not used simply to transmit power, although it can, as will be discussed below. Instead, the fluid itself is also used as the structural load bearing element with the hose constraining and containing the fluid. That is, the pressure in the fluid is the load divided by the cross-sectional area of the fluid. Returning to flexible load-bearing elements more generally, linear masses for such assemblies are on the order of less than 1 kg per meter. As a result, it is possible to build a two leg solution for approximately 2 kg, which is significantly less than the prior art exoskeleton designs. Additionally, the resulting system can bear the weight of a soldier's ruck and armor without needing electrical power.

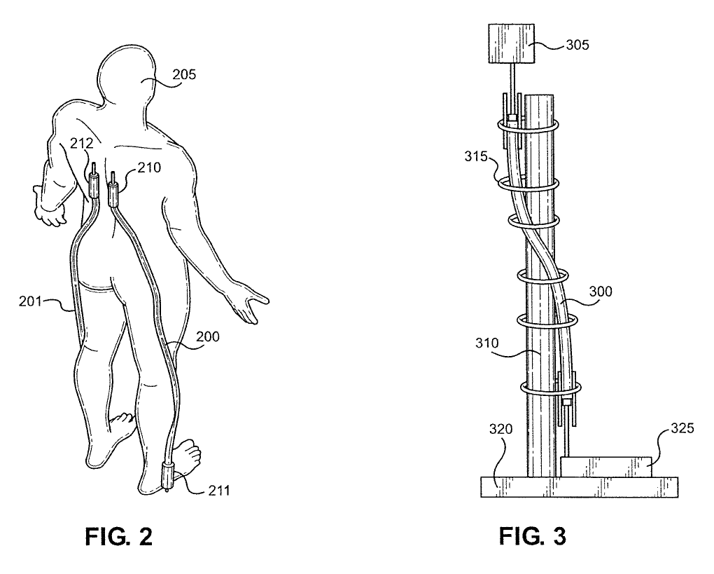

With reference now to FIG. 2, a portion of a load-bearing assembly in accordance with the present invention is shown. Slender, flexible hoses 200 and 201 hold an incompressible fluid and are wrapped tightly against the body of a wearer 205. Preferably, hoses 200 and 201 are arranged along lines of non-extension, as discussed above. However, in order to better illustrate the concept, the routing of hoses 200 and 201 does not exactly follow lines of non-extension in FIG. 2. A form-fitting textile (not shown) is preferably worn by wearer 205 to hold hoses 200 and 201 in place and prevent buckling. Hydraulic cylinders 210-213 are provided at the ends of hoses 200 and 201, although cylinder 213 is not visible in FIG. 2 but is present in FIG. 5. Cylinders 210-213 provide an interface between hydraulic fluid in hoses 200 and 201 and the ground or a load. While no load is shown in FIG. 2, cylinders 210 and 212 connect to the load when present, as will be described below. In some embodiments, further interfacing between the load and cylinders 210 and 212 is required. Also, in some embodiments, push-pull cables are used rather than the hydraulic cables. In addition, the routing of hoses 200 and 201 (or the push-pull cables) can vary from embodiment to embodiment to follow the different lines of non-extension.

FIG. 3 illustrates a test setup that was used as a proof of concept of the present invention. A flexible push-pull cable 300 is used to transfer a load (a 25 lb weight 305) around a human stand-in (an aluminum rod 310). Push-pull cable 300 is coupled to rod 310 by a plurality of cable ties, one of which is labeled 315. However, as noted above and as will be discussed below, flexible load-bearing elements of the present invention are preferably coupled to a wearer via a form-fitting textile. Push-pull cable 300 circles halfway around rod 310 in order to demonstrate that it is not necessary for the load to be perfectly positioned above the portion of a support surface to which the load is transferred. Typically, the support surface is the surface upon which a wearer is standing, e.g., a floor or the ground. Accordingly, rod 310 terminates on a floor 320. However, push-pull cable 300 terminates on a scale 325 for purposes of illustrating the present invention. Specifically, scale 325 reads 25 lb, thereby demonstrating that the load from weight 305 is transferred by push-pull cable 300 to any support surface contacted by push-pull cable 300. As used in this test setup, push-pull cable 300 is a Flexball™ ball bearing control cable available from VPS Control Systems.

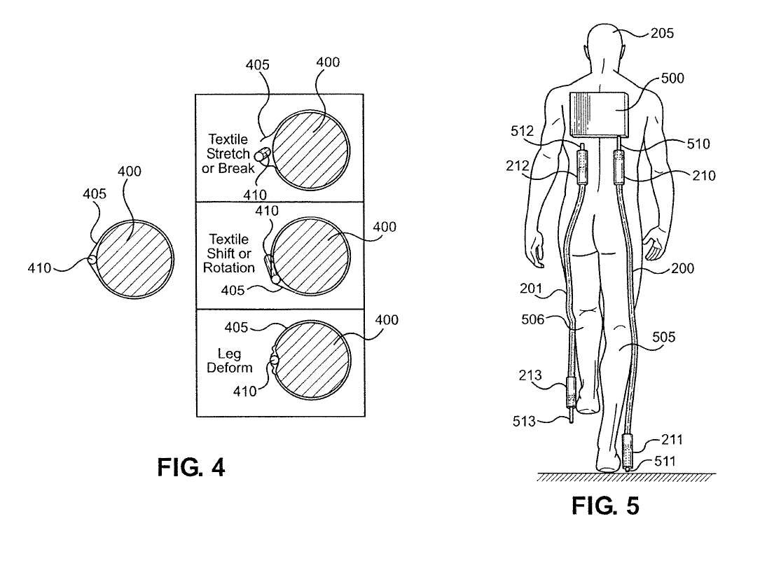

Referring back to the embodiment of FIG. 2, it is important that buckling of hoses 200 and 201 is prevented in order to prevent buckling of the hydraulic fluid column. Since hoses 200 and 201 can buckle if left unsupported for more than a few inches, hoses 200 and 201 are tightly coupled to wearer 205, as noted above. In particular, the load-bearing elements (e.g., hoses 200 and 201) are coupled to a textile in a continuous fashion, with the textile providing a connection to the wearer by virtue of the textile being worn by the wearer. In practice, the textile should resist several failure modes, illustrated in FIG. 4, including: failure of the textile; motion of the textile relative to the wearer; and deformation of the tissue of the wearer's body. The textile failure modes are illustrated around a leg 400 of a wearer, with the textile labeled 405 and the load-bearing element labeled 410. Although there are many ways of addressing such textile failures, in a preferred embodiment, tearing failures are prevented through use of appropriate high-strength fibers. Also, motion of the textile relative to the wearer is controlled by using tensile structures that cross the line or lines of non-extension along which the load-bearing elements are arranged (at a generally perpendicular angle, for example) in order to couple the load-bearing elements to the wearer's limbs in a manner similar to the cable ties shown in FIG. 3. Deformation of the wearer's tissue is controlled by incorporating semi-rigid elements in areas of concern. Preferably, the textile is sized to an individual wearer. However, in some embodiments, it is possible to adjust the size of the textile with buckles, webbing triglides, Velcro™ and other fabric adjustment methods known in the art.

It is also important to prevent pressure rupture of the hydraulic hoses (e.g., hoses 200 and 201 of FIG. 2) by using conventional hydraulic hoses. In some embodiments using a large −8 size hydraulic hose, the pressure developed when supporting 75 lb is 382 psi. In other embodiments, a smaller −4 hose is used, resulting in a pressure of 1552 psi. Hydraulic hoses typically feature working pressure up to 3,000 to 5,000 psi, which provides a comfortable factor of safety. While many types of hydraulic hose are known in the art, hoses featuring tight bend radii and fibrous exteriors that can be integrated into a textile are preferred.

Turning to FIG. 5, the load-bearing assembly of FIG. 2 is shown in combination with a load 500 as wearer 205 takes a step. In particular, a right leg 505 of wearer 205 is in stance, and a left leg 506 is in swing. Hose 200, which is coupled to the stance leg (i.e., right leg 505), bears the weight of load 500 because cylinder 211 contacts the ground. Hose 201, which is coupled to the swing leg (i.e., left leg 506), does not bear the weight of load 500 because cylinder 213 is not in contact with the ground. Therefore, because the left load-bearing element is not in contact with the ground, the left load-bearing element does not support load 500, and a piston 512 of cylinder 212 falls away from load 500. In a preferred embodiment, springs (not shown) bias pistons 510-513 of cylinders 210-213 so that cylinders 210-213 do not lose contact with load 500, but the effect is exaggerated here for illustration. In some embodiments, the load-bearing assembly will further include a fluid reservoir (not shown) to allow resizing, and pressure sensors (not shown) to record system loading. In addition, it should be understood that hoses 200 and 201 are the same length, with hose 201 simply appearing foreshortened in this perspective.

There are many possible embodiments of the present invention, resulting in a continuum of systems. For some applications, such as helping a soldier at a checkpoint who is wearing armor, load-bearing with a passive system (such as shown in FIGS. 2 and 5) is sufficient. The passive embodiment is advantageous because it is very simple and requires neither a battery nor a computer to operate. However, simply reducing the effective weight (but not the mass) of the trunk can have a metabolic benefit, this benefit is generally not sufficient for all applications. In order to improve agility during a multi-hour march or to move at a high rate of speed, some transfer of energy to the soldier is highly desirable. Therefore, in a preferred powered embodiment, hydraulic fluid is selectively pumped into the load-bearing elements so that the load-bearing elements push directly against the ground and load. The hydraulic power unit used to provide this assistance can take any of a number of forms well known in the art, with certain preferred arrangements being detailed below. Such embodiments can provide a propulsive assistance at toe-off that, while analogous to ankle actuation, is considered to be far more effective because the resultant is not simply applied to the shank but instead the load being carried. It is also possible to provide powered assistance when using a push-pull cable by pushing on the ends of the push-pull cable, for example with an electric motor at the upper end of the load bearing element. It is also possible to use hydraulic load bearing elements and push on the ends with one or more electric motors. However, depending on the application, it can be simpler, and therefore preferable, to plumb a hydraulic power unit into the hydraulic lines, as will be discussed below.

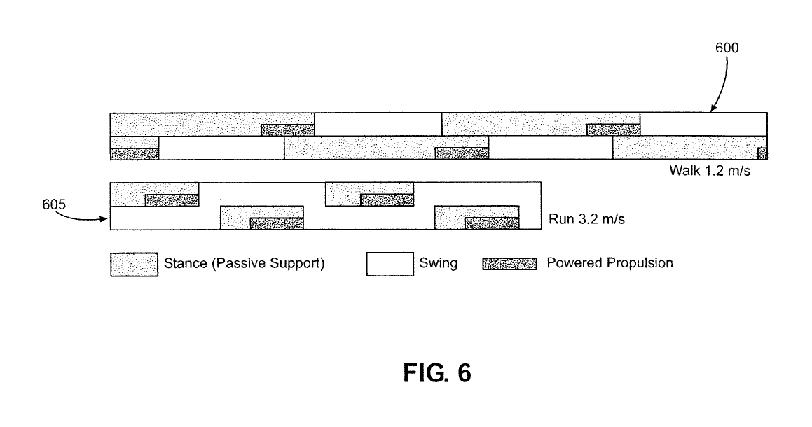

A timing diagram for a powered embodiment of the present invention is shown in FIG. 6. In particular, a timing diagram for walking is shown at 600, and a timing diagram for running is shown at 605. The upper portion of each diagram represents steps or strides taken with one leg (e.g., a left leg), while the lower portion of each diagram represents steps or strides taken with the other leg (e.g., a right leg). As can be seen in FIG. 6, passive support (i.e., load bearing) occurs during any stance cycle in walking or running. By injecting power into the load-bearing elements late in the stance cycle, the powered embodiment also provides propulsion during walking or running. It should be noted that, as shown in FIG. 6, powered propulsion occupies a greater percentage of the gait cycle during running because of the greater propulsive requirements of running. It is also important to note that the power can be injected hydraulically, as will be discussed below, or by using one or more electric motors and mechanical linkages connected to the load bearing elements.

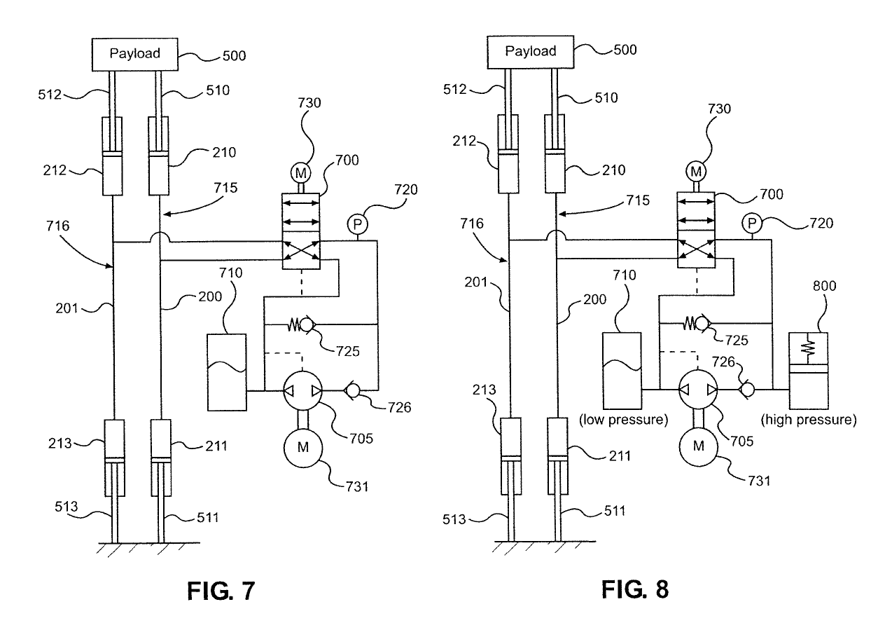

Although there are a number of possible powered hydraulic embodiments of the present invention, FIG. 7 shows one relatively simple embodiment in which a selector valve 700 connects one load-bearing element at a time to a pump 705 and connects the other load-bearing element to a reservoir 710. The load-bearing elements are shown schematically as pairs of hydraulic cylinders each connected by a hose. Specifically, a right loading-bearing element 715 includes hose 200, cylinders 210 and 211 and pistons 510 and 511, while a left load-bearing element 716 includes hose 201, cylinders 212 and 213 and pistons 512 and 513. In addition, FIG. 7 shows a pressure indicator 720, check valves 725 and 726 and motors 730 and 731, which drive selector valve 700 and pump 705, respectively. As a result, motor 731 can drive pump 705 to cause hydraulic fluid to be sent to load-bearing elements 715, for example, thereby providing propulsive assistance through movement of piston 511.

FIG. 8 shows another powered hydraulic embodiment in accordance with the present invention. In addition to those components shown in FIG. 7, a high-pressure accumulator 800 is included. As a result, the load on hydraulic pump 705 is evened out since pump 705 need only make the average pressure in the system. In addition to the valve states shown in FIGS. 7 and 8, if desired, a third valve state can be provided that does not permit any flow from reservoir 710 so that neither of load-bearing elements 715 and 716 is pressurized. Also, selector valve 700 can take other forms and be actuated in other ways. For example, selector valve 700 can take the form of a rotary valve or be actuated by a solenoid rather than motor 730.

With reference to the present invention more generally, in some embodiments, there is no payload, and the upper ends of the flexible load-bearing elements push against the torso of the wearer or a harness that is connected to the wearer. In such embodiments, the present invention reduces the effective weight of the wearer, which can help reduce joint injuries. This effective weight reduction is also useful during rehabilitation from an injury.

In general then, the present invention is directed to an exoskeleton comprising at least one flexible load-bearing element. The load-bearing element includes a flexible hose, sleeve or cable having a first end (or end portion) and a second end (or end portion), the second end being opposite the first end. The first end is engageable with a load and transfers a weight of the load to the hose, sleeve or cable. The hose, sleeve or cable transfers the weight of the load from the first end to the second end, and the second end transfers the weight of the load to a support surface upon which the exoskeleton is supported. In other words, the hose, sleeve or cable transmits a compressive load from the exoskeleton to the support surface.

In one embodiment, the load-bearing element is a mechanical control cable or a push-pull cable. In another embodiment, the load-bearing element includes a first hydraulic cylinder located at the first end and a second hydraulic cylinder located at the second end. In this embodiment, the hose, sleeve or cable is a hydraulic hose containing hydraulic fluid. Furthermore, the first hydraulic cylinder, the second hydraulic cylinder and the hydraulic hose form a portion of a hydraulic circuit. The hydraulic circuit further includes a pump, which selectively increases the amount of hydraulic fluid in the hydraulic hose. As a result, power is provided to the load-bearing element in the form of propulsive assistance for the wearer of the exoskeleton. The hydraulic circuit also includes a valve having a first state and a second state. In the first state, the pump increases the amount of hydraulic fluid in a first load-bearing element, and, in the second state, the pump increases the amount of hydraulic fluid in a second load-bearing element.

Preferably, the load-bearing element follows one or more lines of non-extension of the wearer. Specifically, the load-bearing element follows the one or more lines of non-extension over at least a majority (i.e., greater than 50%) of the length of the load-bearing element. In one embodiment, the first end is located adjacent the torso of the wearer, and the second end is located adjacent a foot of the wearer. In such an embodiment, the load-bearing element preferably follows one or more lines of non-extension from the wearer's torso to the wearer's foot. In certain embodiments, the first end directly contacts the load, and the second end directly contacts the support surface. Alternatively, the first and second ends indirectly contact the load and support surface through load-transmitting structures such that the compressive load is still transferred from the exoskeleton to the support surface through the load-bearing element.

The exoskeleton further comprises a textile configured to be worn by the wearer. The hose, sleeve or cable is coupled to the textile. Preferably, the textile is form-fitting with respect to the wearer, i.e., the textile fits tightly against the wearer's body. This allows the load-bearing element to transmit the compressive load to the support surface without buckling of the load-bearing element, which is otherwise sufficiently flexible so as to buckle under the load.

Based on the above, it should be readily apparent that the present invention provides an exoskeleton that helps a wearer bear the weight of a load through the use of flexible structures that also provide propulsive assistance. Although described with reference to preferred embodiments, it should be readily understood that various changes or modifications could be made to the invention without departing from the spirit thereof. In general, the invention is only intended to be limited by the scope of the following claims.

1. An exoskeleton comprising:
a load-bearing element including a flexible hose, sleeve or cable, the hose, sleeve or cable having a first end portion and a second end portion opposite the first end portion, wherein:
the first end portion is engageable with a load;
the first end portion is configured to transfer a weight of the load to the flexible hose, sleeve or cable;
the flexible hose, sleeve or cable is configured to be placed in compression to transfer the weight of the load from the first end portion to the second end portion; and
the second end portion is configured to transfer the weight of the load to a support surface upon which the exoskeleton is supported.

2. The exoskeleton of claim 1, wherein the load-bearing element is a mechanical control cable or a push-pull cable.

3. The exoskeleton of claim 1, wherein the load-bearing element further includes:
a first hydraulic cylinder located at the first end portion; and
a second hydraulic cylinder located at the second end portion, wherein the flexible hose, sleeve or cable is a hydraulic hose containing hydraulic fluid.

4. The exoskeleton of claim 3, wherein the first hydraulic cylinder, the second hydraulic cylinder and the hydraulic hose form a portion of a hydraulic circuit that further comprises a pump, wherein the pump is configured to increase an amount of hydraulic fluid in the hydraulic hose to provide power to the load-bearing element.

5. The exoskeleton of claim 4, wherein the load-bearing element constitutes a first load-bearing element, the exoskeleton further comprises a second load-bearing element and the hydraulic circuit further includes a valve having a first state in which the pump is configured to increase an amount of hydraulic fluid in the first load-bearing element, and a second state in which the pump is configured to increase an amount of hydraulic fluid in the second load-bearing element.

6. The exoskeleton of claim 4, wherein the hydraulic circuit further includes a reservoir and an accumulator.

7. (canceled)

8. The exoskeleton of claim 1, wherein the load-bearing element is configured to follow at least one line of non-extension of a wearer of the exoskeleton.

9. The exoskeleton of claim 8, wherein the load-bearing element is configured to follow the at least one line of non-extension over at least a majority of a length of the load-bearing element.

10. The exoskeleton of claim 8, wherein:
the second end portion is configured to be located adjacent to a foot of the wearer; and
the first end portion is configured to be located adjacent to a torso of the wearer.

11. (canceled)

12. The exoskeleton of claim 1, further comprising a textile configured to be worn by a wearer of the exoskeleton, wherein the hose, sleeve or cable is coupled to the textile.

13. The exoskeleton of claim 12, wherein the textile is form-fitting with respect to the wearer.

14. (canceled)

15. The exoskeleton of claim 1, wherein the first end portion is configured to directly contact the load and the second end portion is configured to directly contact the support surface.

16. (canceled)

17. A method of transferring a weight of a load from an exoskeleton to a support surface upon which the exoskeleton is supported, the exoskeleton comprising a load-bearing element including a flexible hose, sleeve or cable, the hose, sleeve or cable having a first end portion and a second end portion opposite the first end portion, the method comprising:
transferring the weight of the load to the first end portion of the load-bearing element;
placing the load bearing element in compression in transferring the weight of the load from the first end portion of the load-bearing element to the second end portion of the load-bearing element; and
transferring the weight of the load from the second end portion of the load-bearing element to the support surface.

18. The method of claim 17, wherein:
the load-bearing element is a mechanical control cable or a push-pull cable;
transferring the weight of the load to the first end portion includes transferring the weight of the load to a first end portion of the mechanical control cable or push-pull cable;
transferring the weight of the load from the first end portion to the second end portion includes transferring the weight of the load from the first end portion of the mechanical control cable or push-pull cable to a second end portion of the mechanical control cable or push-pull cable; and
transferring the weight of the load from the second end portion to the support surface includes transferring the weight of the load from the second end portion of the mechanical control cable or push-pull cable to the support surface.

19. The method of claim 17, wherein:
the flexible hose, sleeve or cable is a hydraulic hose containing hydraulic fluid;
transferring the weight of the load to the first end portion includes transferring the weight of the load to a first hydraulic cylinder;
transferring the weight of the load from the first end portion to the second end portion includes transferring the weight of the load from the first hydraulic cylinder to a second hydraulic cylinder via the hydraulic hose; and
transferring the weight of the load from the second end portion to the support surface includes transferring the weight of the load from the second hydraulic cylinder to the support surface.

20. The method of claim 19, wherein the first hydraulic cylinder, the second hydraulic cylinder and the hydraulic hose form a portion of a hydraulic circuit that further comprises a pump, the method further comprising:
increasing an amount of hydraulic fluid in the hydraulic hose with the pump to provide power to the load-bearing element.

21. The method of claim 20, wherein the load-bearing element constitutes a first load-bearing element, the exoskeleton further comprises a second load-bearing element and the hydraulic circuit further includes a valve having a first state and a second state, the method further comprising:
increasing an amount of hydraulic fluid in the first load-bearing element with the pump when the valve is in the first state; and
increasing an amount of hydraulic fluid in the second load-bearing element with the pump when the valve is in the second state.

22. The method of claim 17, wherein:
the load-bearing element is configured to follow at least one line of non-extension of a wearer of the exoskeleton over at least a majority of a length of the load-bearing element; and
transferring the weight of the load from the first end portion to the second end portion includes transferring the weight of the load along the at least one line of non-extension over at least a majority of the length of the load-bearing element.

23. (canceled)

24. The method of claim 22, wherein transferring the weight of the load from the first end portion to the second end portion further includes at least one of:
transferring the weight of the load to a location adjacent the foot of the wearer; and
transferring the weight of the load from a location adjacent a torso of the wearer.

25-26. (canceled)

27. The method of claim 17, wherein at least one of:
transferring the weight of the load to the first end portion includes directly contacting the load with the first end portion; and
transferring the weight of the load from the second end portion to the support surface includes directly contacting the support surface with the second end portion.

28. (canceled)
